(19) United States
(12) Patent Application Publication
(10) Pub. No.: US 2025/0142342 A1
(43) Pub. Date: May 1, 2025

(54) SYSTEM FOR INFORMATION SECURITY MANAGEMENT OVER 5G OPEN ARCHITECTURE INFRASTRUCTURES

(71) Applicant: NATIONAL YANG MING CHIAO TUNG UNIVERSITY, HSINCHU CITY (TW)

(72) Inventors: EN-CHENG LIOU, HSINCHU CITY (TW); YU-CHEE TSENG, HSINCHU CITY (TW); CHUNG-HSIANG CHENG, NEW TAIPEI CITY (TW); TZU-HANG LIN, HSINCHU COUNTY (TW)

(21) Appl. No.: 18/396,523

(22) Filed: Dec. 26, 2023

(30) Foreign Application Priority Data
Oct. 31, 2023 (TW) 112141766

(51) Int. Cl. H04W 12/67; H04L 41/16; H04W 24/08

(52) U.S. Cl. CPC H04W 12/67; H04L 41/16; H04W 24/08

(57) ABSTRACT

A system for information security management over 5G open architecture infrastructures, in which a controlled 5G open architecture system connected to the 5G open architecture central management system and performs data transmission. A 5G virtualized infrastructure information security monitoring system, arranged in the 5G open architecture central management system, selects the 5G open architecture central management system, the controlled 5G open architecture system, an intelligent controller management platform, or the 5G virtualized infrastructure information security monitoring system as a scanning target for monitoring. The 5G virtualized infrastructure information security monitoring system includes multiple types of information security risk models and scans the scanning target based on the usage restrictions of one of the multiple types of information security risk models, thereby generating an information security risk result. The 5G virtualized infrastructure information security monitoring system provides an analytical recommendation based on the information security risk result.

### BACKGROUND OF THE INVENTION

This application claims priority for the TW patent application No. 112141766 filed on 31 Oct. 2023, the content of which is incorporated by reference in its entirely.

### FIELD OF THE INVENTION

The invention relates to a field for network management, particularly to a system for information security management over 5G open architecture infrastructures.

### DESCRIPTION OF THE RELATED ART

The demand for the mobile communication industry supply chain encounters three categories of issues. The first core issue involves information security requirements for network operations, cost control, and management concerns. The second issue pertains to parameter adjustments in the deployment of telecommunication equipment, allowing for automation and intelligent customization with information security assurance. The third issue involves conducting information security testing for the development and implementation of applications for telecommunication public networks or dedicated networks, expediting the implementation of application services for mobile communication dedicated networks.

Firstly, the first core issue arises when mobile communication systems are in inspection and operation. Traditional testing systems and tools are primarily hardware-based in design and development. Consequently, the related testing equipment can only deploy a single device. However, there is a significant disparity in information security risks when telecom systems are put into actual commercial use. This leads to persistent threats to information security operations. Alternatively, it may not be feasible to provide a large quantity of information security validations during the research and development phase. Typically, human intervention is relied upon for controlling, managing, and monitoring the information security operations. These issues are particularly severe in the 5G open architecture. The second core issue emerges during the development or operation of equipment. Considerable information security personnel are often required for laboratory and field testing. Human-induced errors in operation are unavoidable. There are limitations experienced by testing personnel. Furthermore, there are concerns for information security management and results may not necessarily be verifiable or quickly adjustable. The third issue pertains to the critical conducting testing for developing the application services for telecommunication public networks or dedicated networks. When the mobile communication systems develop application services for telecommunication public networks or dedicated networks, the key obstacles have typically excluded functional issues. One intends to evaluate the information security quality of performance, the user experience of application quality, and the impact on existing network services. The telecom network service industry finds it challenging to directly simulate and confirm the development performance of relevant new application service and introduce assessments of information security risks on the network using existing environments or simulation tools and services. This is because the new application service employs a separate enclosed environment.

To overcome the abovementioned problems, the invention provides a system for information security management over 5G open architecture infrastructures, so as to solve the afore-mentioned problems of the prior art.

### SUMMARY OF THE INVENTION

The primary objective of the invention is to provide a system for information security management over 5G open architecture infrastructures, which arranges an underlying management control layer in the underlying layer of a 5G open architecture central management system for management. Within the underlying layer, control of the underlying antenna signals and management of upper-layer application protocols are generated based on corresponding control methods and parameter adjustments. This system also supports artificial intelligence (AI)-assisted analytical and determination models, enabling the rapid adjustment of underlying parameters or the improvement of implementations. Furthermore, it can be anticipated that within the existing testing environment, management cost, hardware and software costs, as well as time costs, can be significantly reduced for the specified target.

Another objective of the invention is to provide a system for information security management over 5G open architecture infrastructures, which alters the process of introducing application services into public networks or dedicated networks. The system for information security management over 5G open architecture infrastructures minimizes risks within the process, allowing for customized user behavior simulation for users.

In order to achieve the foregoing purposes, the invention provides a system for information security management over 5G open architecture infrastructures, which includes a 5G open architecture central management system, at least one controlled 5G open architecture system, and a 5G virtualized infrastructure information security monitoring system. The controlled 5G open architecture system is connected to the 5G open architecture central management system and configured to perform data transmission with the 5G open architecture central management system. The 5G virtualized infrastructure information security monitoring system is arranged in the 5G open architecture central management system and configured to select the 5G open architecture central management system or the controlled 5G open architecture system as a scanning target for monitoring. The 5G virtualized infrastructure information security monitoring system, including multiple types of information security risk models, is configured to scan the scanning target based on the usage restrictions of one of the multiple types of information security risk models, thereby generating an information security risk result. The 5G virtualized infrastructure information security monitoring system is configured to provide an analytical recommendation based on the information security risk result.

In an embodiment of the invention, the 5G open architecture central management system includes at least one control interface, an underlying management control layer, and an intelligent controller management platform. The control interface is connected to the controlled 5G open architecture system. The underlying management control layer is connected to the at least one control interface. The intelligent controller management platform includes the 5G virtualized infrastructure information security monitoring system. The intelligent controller management platform is connected to the control interface through the underlying management control layer, thereby connecting to the controlled 5G open architecture system. The intelligent controller management platform is configured to start up the 5G virtualized infrastructure information security monitoring system, thereby starting to exchange transmission information with the controlled 5G open architecture system.

In an embodiment of the invention, the 5G virtualized infrastructure information security monitoring system includes a database access module, an intelligent monitoring scheduling module, an intelligent monitoring module, an artificial intelligence (AI) module scanner, an information security risk analyzer, and an artificial intelligence (AI) module analyzer. The database access module is configured to store the information security risk models. The intelligent monitoring scheduling module is connected to the database access module and configured to select one of the information security risk models. The intelligent monitoring module is connected to the intelligent monitoring scheduling module and configured to employ the intelligent monitoring scheduling module to select the controlled 5G open architecture system, the 5G open architecture central management system, the intelligent controller management platform, or the 5G virtualized infrastructure information security monitoring system and provide it for the database access module to monitor. The database access module is configured to monitor and store the usage restrictions of the information security risk models and the information security risk result for the scanning target in the intelligent monitoring module. The AI module scanner is connected to the intelligent monitoring scheduling module and configured to monitor or scan an object selected by the intelligent monitoring module. The AI module scanner is configured to determine whether there is an information security risk based on the information security risk model selected by the intelligent monitoring scheduling module. The information security risk analyzer is connected to the intelligent monitoring scheduling module and configured to collect results monitored or scanned by the AI module scanner. The information security risk analyzer is configured to determine whether artificial intelligence (AI) analysis needs to be performed on the information security risk based on rules made by the intelligent monitoring scheduling module. The AI module analyzer is connected to the intelligent monitoring scheduling module. When the information security risk analyzer determines that AI analysis needs to be performed on the information security risk, the AI module analyzer provides relevant analytical recommendations.

In an embodiment of the invention, the 5G virtualized infrastructure information security monitoring system further includes a virtualized underlying layer, which is connected to the database access module, the intelligent monitoring scheduling module, the intelligent monitoring module, the AI module scanner, the information security risk analyzer, and the AI module analyzer and configured to coordinate resources of the 5G virtualized infrastructure information security monitoring system.

In an embodiment of the invention, when the intelligent monitoring module selects the intelligent controller management platform, a module within the intelligent controller management platform that is at the same level as the 5G virtualized infrastructure information security monitoring system is selected.

In an embodiment of the invention, when the AI module scanner establishes a control plane connection with the specified controlled 5G open architecture system based on 3rd generation partnership project (3GPP) standard or open radio access network (O-RAN) standard, the controlled 5G open architecture system generates a corresponding control signal based on results related to information exchanged with the AI module scanner. The controlled 5G open architecture system starts up, shuts down, or establishes a connection based on the control signal, and sequentially reports real-time messages and results of scanning or monitoring the controlled 5G open architecture system back to the AI module scanner.

In an embodiment of the invention, the control signal includes combinations of a connection version, virtualization-related parameters, statistic information, relevant control plane parameters, and data fields expected to be collected.

In an embodiment of the invention, when the AI module scanner establishes a control plane connection with the specified controlled 5G open architecture system based on non-3rd generation partnership project (3GPP) standard or non-open radio access network (O-RAN) standard, the controlled 5G open architecture system generates a corresponding control signal based on results related to information exchanged with the AI module scanner. The controlled 5G open architecture system starts up, shuts down, or establishes a connection based on the control signal, and sequentially reports real-time messages and the results of scanning or monitoring the controlled 5G open architecture system back to the AI module scanner. The control signal includes combinations of a connection version, virtualization-related parameters, statistic information, relevant control plane parameters, and data fields expected to be collected.

In an embodiment of the invention, the control plane connection includes process discrepancies, various transmission protocols, or erroneous packet headers or contents, enabling completion of scanning on information security risks, fuzz testing, or message comparison for databases.

In an embodiment of the invention, when the AI module scanner establishes a data plane connection with the specified controlled 5G open architecture system based on 3rd generation partnership project (3GPP) standard, the controlled 5G open architecture system generates a corresponding control signal based on results related to information exchanged with the AI module scanner. The controlled 5G open architecture system starts up, shuts down, or establishes a connection based on the control signal, and sequentially reports real-time messages and results of scanning or monitoring the controlled 5G open architecture system back to the AI module scanner. Data plane messages transmitted by the data plane connection include combinations of data types, relevant data plane parameters, and data fields expected to be collected.

In an embodiment of the invention, when the AI module scanner establishes a data plane connection with the specified controlled 5G open architecture system based on non-3rd generation partnership project (3GPP) standard or non-open radio access network (O-RAN) standard, the controlled 5G open architecture system generates a corresponding control signal based on results related to information exchanged with the AI module scanner. The controlled 5G open architecture system starts up, shuts down, or establishes a connection based on the control signal, and sequentially reports real-time messages and the results of scanning or monitoring the controlled 5G open architecture system back to the AI module scanner. Data plane messages transmitted by the data plane connection include combinations of data types, relevant data plane parameters, and data fields expected to be collected.

In an embodiment of the invention, the controlled 5G open architecture system includes a central unit, a distributed unit, a radio unit, and an antenna.

Below, the embodiments are described in detail in cooperation with the drawings to make easily understood the technical contents, characteristics and accomplishments of the invention.

### BRIEF DESCRIPTION OF THE DRAWINGS

FIG. 1 is a diagram schematically illustrating a system for information security management over 5G open architecture infrastructures according to an embodiment of the invention;

FIG. 2 is a diagram schematically illustrating a 5G open architecture central management system according to an embodiment of the invention;

FIG. 3 is a diagram schematically illustrating a 5G virtualized infrastructure information security monitoring system according to an embodiment of the invention;

FIG. 4 is a diagram schematically illustrating a controlled 5G open architecture system according to an embodiment of the invention; and

FIG. 5 is a flowchart of transmitting information with the 5G virtualized infrastructure information security monitoring system and the 5G open architecture central management system according to an embodiment of the invention.

### DETAILED DESCRIPTION OF THE INVENTION

The technical solutions in the embodiments of the present invention will be clearly and completely described below with reference to the drawings in the embodiments of the present invention. Obviously, the described embodiments are part of the embodiments of the present invention, not all of the embodiments. Based on the embodiments of the present invention, all other embodiments obtained by those skilled in the art without making inventive efforts should be included within the scope of the present invention.

It should be understood that, when used in this specification and the scope of the claims, the terms “comprising” and “including” refer to the presence of a stated feature, whole, step, operation, element, and/or component, but does not exclude the presence or addition of one or more other features, wholes, steps, operations, elements, components and/or combinations of these.

It should also be understood that the terms used in the specification of the present invention is only used to describe particular embodiments but not intended to limit the present invention. As used in this specification and the claims, the singular forms “a,” “an,” and “the” are intended to include the plural forms unless the context clearly dictates otherwise.

It should further be understood that the terms “and/or” used in the specification and the claims refer to any and all possible combinations of one or more of the associated listed items and include these combinations.

The term “endpoints” referred to in this specification includes but is not limited to multiple user equipment (UE), Internet of things (IoT) devices, narrowband Internet of things (NB-IoT) devices, any other types of devices capable of operating in authorized radio frequency bands, unlicensed radio frequency bands, and wireless telecommunications environments defined by any country, and combinations of other types of telecommunications radio frequency units.

The term “controlled 5G open architecture system” as referred to in the specification includes but is not limited to base station (e.g., eNB or gNB), central unit (CU), distributed unit (DU), radio remote unit/remote radio head (RRU/RRH), small cell, femto cell, pico cell, virtual base station, satellite base station, or any other type of interface connection device in a telecommunication wireless environment.

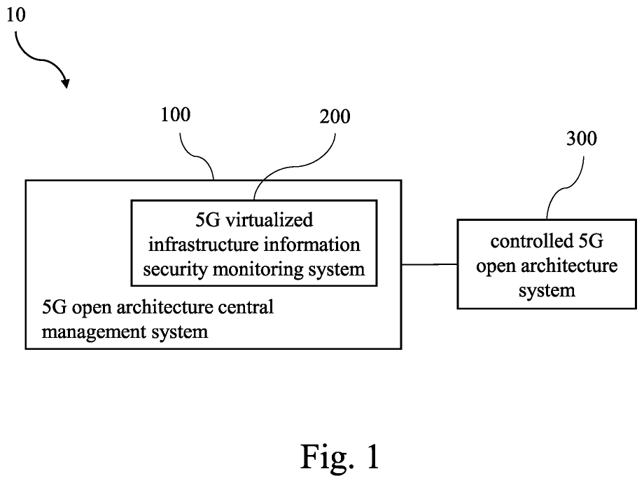

The invention provides a system for information security management over 5G open architecture infrastructures. Referring to FIG. 1, which is a diagram schematically illustrating a system 10 for information security management over 5G open architecture infrastructures according to an embodiment of the invention. The system 10 for information security management over 5G open architecture infrastructures of the invention includes a 5G open architecture central management system 100, a 5G virtualized infrastructure information security monitoring system 200, and a controlled 5G open architecture system 300. The 5G open architecture central management system 100 is connected to the controlled 5G open architecture system 300. The 5G virtualized infrastructure information security monitoring system 200 is arranged in the 5G open architecture central management system 100. The infrastructure management information determined by the system 10 for information security management over 5G open architecture infrastructures may be generated by the 5G virtualized infrastructure information security monitoring system 200 and controlled by the 5G open architecture central management system 100. The 5G virtualized infrastructure information security monitoring system 200 scans the controlled 5G open architecture system 300 or the 5G open architecture central management system 100. Finally, the 5G virtualized infrastructure information security monitoring system 200 is expected to play an important role in the information security operation and monitoring aspects of the 5G open architecture central management system 100 and the controlled 5G open architecture system 300. The architecture and the functions of the 5G open architecture central management system 100, the 5G virtualized infrastructure information security monitoring system 200, and the controlled 5G open architecture system 300 are described as follows in detail.

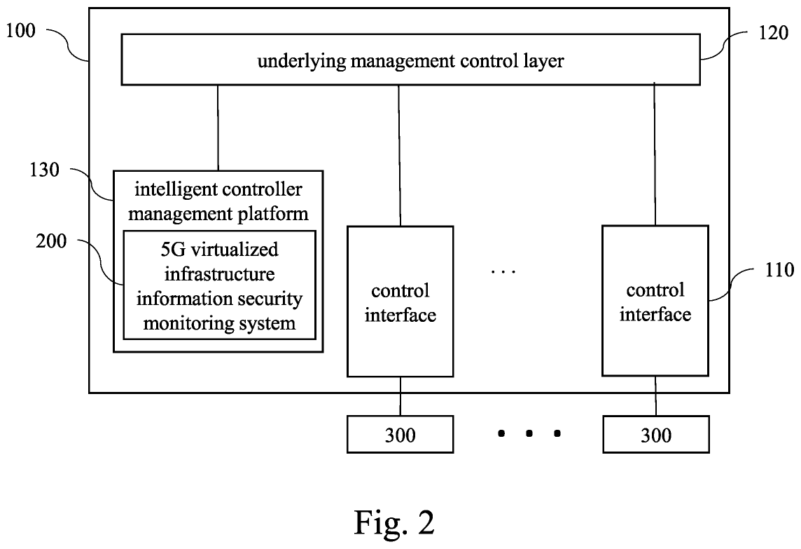

Please refer to FIG. 2, which is a diagram schematically illustrating a 5G open architecture central management system according to an embodiment of the invention. The 5G open architecture central management system 100 includes at least one control interface 110, an underlying management control layer 120, and an intelligent controller management platform 130. The intelligent controller management platform 130 includes the 5G virtualized infrastructure information security monitoring system 200. The intelligent controller management platform 130 is connected to the underlying management control layer 120 that communicates with the 5G open architecture central management system 100. The underlying management control layer 120 is connected to the controlled 5G open architecture system 300 through the control interface 110. Thus, the intelligent controller management platform 130 and the controlled 5G open architecture system 300 may communicate with each other. The intelligent controller management platform 130 includes the 5G virtualized infrastructure information security monitoring system 200. In a wired or virtualized manner, the intelligent controller management platform 130 is connected to the 5G open architecture central management system 100 through the underlying 5 management control layer 120.

The hardware of the 5G open architecture central management system 100 can consist of an x86 server platform, which includes central processing units (CPUs), memories, hard disks, and motherboards. In other embodiments, the 5G open architecture central management system 100 may be arranged in the local hardware or the cloud-based hardware in the form of virtual machines, providing the same computational capability and latency as the foregoing hardware and having an interface for signal transmission with the controlled 5G open architecture system 300. In other embodiments, the 5G open architecture central management system 100 includes hardware architectures with identical computational capability and latency, such as a combination of advanced RISC machine (ARM) systems or other embedded systems. In other embodiments, the 5G open architecture central management system 100 includes a connection interface expansion module with multi-interface capabilities, such as 1G/10G/25G/40G/100G/400G wired network expansion cards, 802.11 g, 802.11n, 802.11ac, 802.11ax, or other connection interfaces based on optical, electrical, quantum, or acoustic transmission. In other embodiments, the 5G open architecture central management system 100 includes hardware for accelerating artificial intelligence (AI) analysis, such as graphics processing units (GPUs), tensor processing units (TPUs), etc. In other embodiments, the 5G open architecture central management system 100 may include a network acceleration module, such as a network acceleration card, and network expansion cards supporting data plane development kit (DPDK). Consequently, designing the application delivery controller (ADC) hardware on x86 or ARM platforms or the cloud will significantly reduce the equipment hardware and operation management costs of the system 10 for information security management over 5G open architecture infrastructures and enhances the flexibility of deployment and operation management of the system 10 for information security management over 5G open architecture infrastructures.

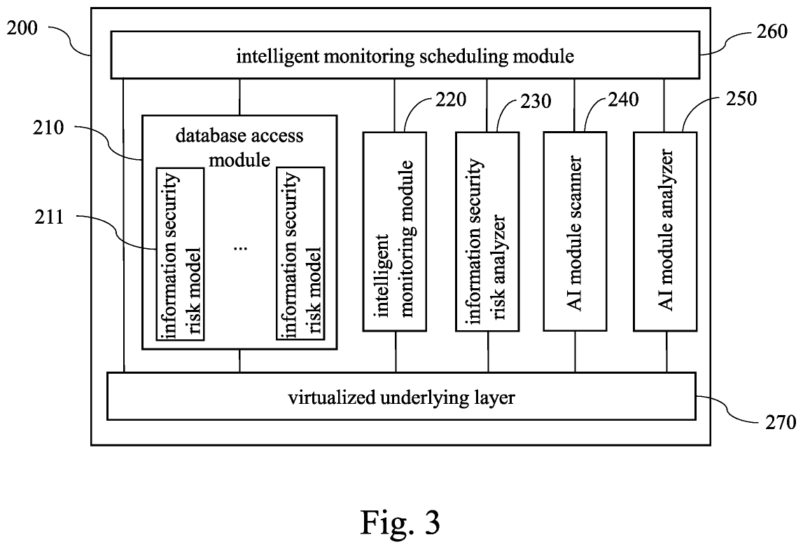

Please refer to FIG. 3, which is a diagram schematically illustrating a 5G virtualized infrastructure information security monitoring system 200 according to an embodiment of the invention. The 5G virtualized infrastructure information security monitoring system 200 includes a database access module 210, an intelligent monitoring module 220, an information security risk analyzer 230, an artificial intelligence (AI) module scanner 240, an artificial intelligence (AI) module analyzer 250, an intelligent monitoring scheduling module 260, and a virtualized underlying layer 270. The database access module 210, the intelligent monitoring module 220, the information security risk analyzer 230, the AI module scanner 240, and the AI module analyzer 250 are connected to the intelligent monitoring scheduling module 260 and the virtualized underlying layer 270. The intelligent monitoring scheduling module 260 is connected to the virtualized underlying layer 270. The virtualized underlying layer 270 is configured to coordinate the resources the components 210, 220, 230, 240, 250, and 260 of the 5G virtualized infrastructure information security monitoring system 200.

The database access module 210 serves as the logical storage area for multiple types of information security risk models 211 with different usage restrictions. The database access module 210 can access these information security risk models 211. Additionally, the database access module 210 can monitor the information security-related parameters of each module in the 5G virtualized infrastructure information security monitoring system 200, evaluate the information security risk results for each environment, and store them in the intelligent monitoring module 220. The intelligent monitoring scheduling module 260 is used to store and select monitoring environments, choose one of the information security risk models 211, and make rules for time when AI analysis should be performed for subsequent monitoring and scanning. Using the intelligent monitoring scheduling module 260, the intelligent monitoring module 220 selects the controlled 5G open architecture system 300, the 5G open architecture central management system 100, the intelligent controller management platform 130, and the 5G virtualized infrastructure information security monitoring system 200 as scanning targets. The intelligent monitoring module 220 selects one of the four scanning targets. The database access module 210 monitors the usage restrictions of the information security risk models 211 and the information security risk results for the scanning target and stores all results in the intelligent monitoring module 220. The AI module scanner 240 monitors or scans the scanning target selected by the intelligent monitoring module 220. Based on the information security risk model 211 selected by the intelligent monitoring scheduling module 260, the AI module scanner 240 determines whether there is the scanning result of an information security risk for the scanning target. The information security risk analyzer 230 collects the results of monitoring or scanning the controlled 5G open architecture system 300 by the AI module scanner 240. Based on the rules made by the intelligent monitoring scheduling module 260, the information security risk analyzer 230 determines information security risks to provide risk analysis and assessment recommendations and determines whether AI analysis needs to be performed. If an analysis is required, the AI module scanner 240 performs an AI algorithm based on the recommendations and performance provided by the information security risk analyzer 230. Furthermore, the risk analysis and assessment recommendations are the content required for the scanning report and required for storage in the intelligent monitoring module 220. Therefore, the information security risk analyzer 230 provides the recommendations and performance for the intelligent monitoring module 220 for management. Before the test begins, the AI module analyzer 250 is responsible for conducting corresponding recommendation analysis, the formulation of assessment recommendation, and version management for the scanning results generated by the AI module scanner 240 according to the requirements of different fields. The AI module analyzer 250 communicates with the database access module 210 during the pre-testing and initialization stages to ensure that the parameters, behaviors, targets and returned data of information security risks required for this environment are consistent with the expected data and converted into presented assessment recommendations provided to the intelligent monitoring module 220. After the scanning stage, when the information security risk analyzer 230 determines that AI analysis needs to be performed on information security risks, the AI module analyzer 250 provides relevant analytical recommendations. Finally, the intelligent monitoring scheduling module 260 performs real-time/non-real-time test analysis based on the parameters, behaviors, and targets of the monitored environment. The intelligent monitoring scheduling module 260 accepts relevant data provided by the intelligent monitoring module 220 based on the signals for test initiation and termination and generates test reports after communicating with the AI module analyzer 250.

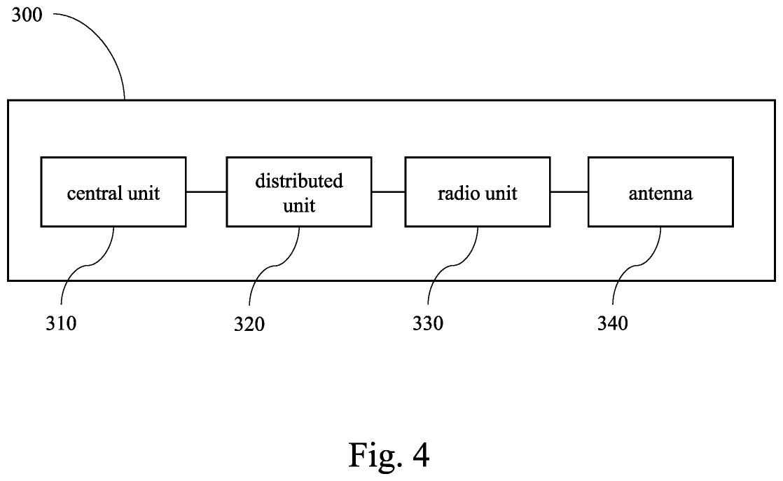

As illustrated in FIG. 4, the controlled 5G open architecture system 300 includes a central unit (CU) 310, a distributed unit (DU) 320, a radio unit (RU) 330, and an antenna 340. The central unit 310 and the distributed unit 320 are composed of CPUs, memories, hard disks, motherboards, I/O interfaces, and transmission interface devices. The central unit 310 and the distributed unit 320 may be distributed in local hardware or the cloud-based hardware or centralized in the single local or cloud-based hardware in a virtualized form. The central unit 310 and the distributed unit 320, as well as the distributed unit 320 and the wireless unit 330, are connected via wired networks. The two connection lines are physically separated. In other embodiments, there may be one or more network switching devices or routing devices between the central unit 310 and the distributed unit 320, as well as between the distributed unit 320 and the wireless unit 330. In further embodiments, logical connections may be provided through network switching devices, wherein physical lines integrated into one or more network switching devices. Some embodiments may include hardware architectures with the same computational capability and latency, such as a combination of ARM systems or other embedded systems. Some embodiments include connection interface expansion modules with multi-interface capabilities, such as 1G/10G/25G/40G/100G/400G wired network expansion cards, 802.11 g, 802.11n, 802.11ac, 802.11ax, or other connection interfaces based on optical, electrical, quantum, or acoustic transmission. Some embodiments include hardware for accelerating artificial intelligence analysis, such as TPUs. Some embodiments include network acceleration modules such as network acceleration cards, network expansion cards supporting DPDK, and network expansion cards that provides hardware acceleration with compute unified device architecture (CUDA) or GPUs. As a result, designing the hardware of the controlled 5G open architecture system 300 on x86 or ARM platforms or the cloud will significantly reduce the hardware and operation management costs of the controlled 5G open architecture system 300.

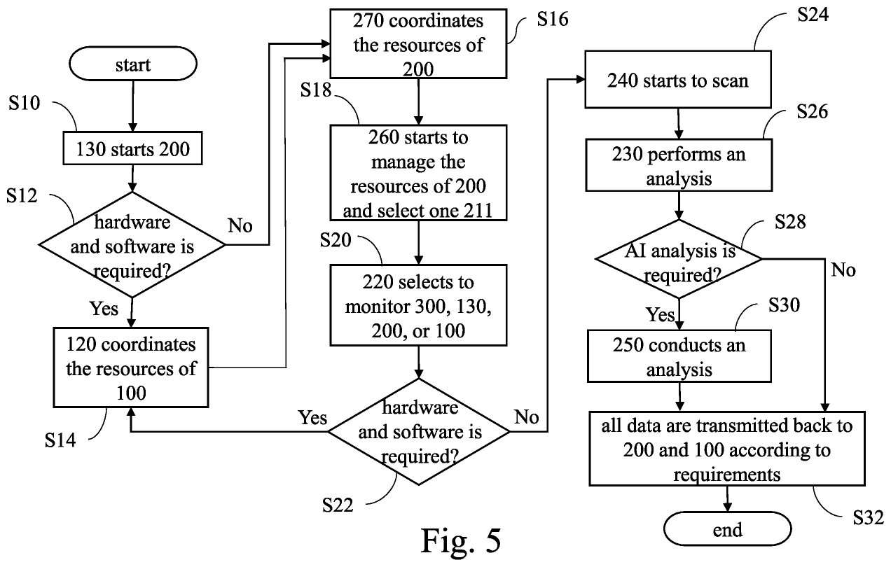

Please refer to FIG. 5, which is a flowchart of transmitting information with the 5G virtualized infrastructure information security monitoring system 200 and the 5G open architecture central management system 100 according to an embodiment of the invention. In Step S10, the intelligent controller management platform 130 of the 5G open architecture central management system 100 starts up the 5G virtualized infrastructure information security monitoring system 200 to transmit information. In Step S12, the intelligent controller management platform 130 determines whether the 5G open architecture central management system 100 requires software or hardware. If the result is no, the process proceeds to Step S16. In Step S16, the internal operation of the 5G virtualized infrastructure information security monitoring system 200 is performed. If the result is yes, the process proceeds to Step S14. In Step S14, the underlying management control layer 120 coordinates the resources of the 5G open architecture central management system 100. Then, in Step S16, when the 5G virtualized infrastructure information security monitoring system 200 starts up, the virtualized underlying layer 270 of the 5G virtualized infrastructure information security monitoring system 200 coordinates the resources related to software and hardware. In Step S18, the intelligent monitoring scheduling module 260 manages the resources of the 5G virtualized infrastructure information security monitoring system 200. During the initialization stage, the intelligent monitoring scheduling module 260 firstly accesses the database access module 210 and one of its internal information security risk models 211 to determine the target for assessing information security risks in this instance. In Step S20, the intelligent monitoring module 220 selects the component of the controlled 5G open architecture system 300 or the 5G open architecture central management system 100 or the internal system module of the intelligent controller management platform 130 having the same level as the 5G virtualized infrastructure information security monitoring system 200 as the scanning target. After selecting the scanning target, the intelligent controller management platform 130 determines whether the scanning target requires software and hardware in Step S22. If the result is yes, the process proceeds to Step S14 such that the underlying management control layer 120 coordinates the resources of the 5G open architecture central management system 100. If the result is no, the process proceeds to Step S24. In Step S24, the AI module scanner 240 monitors or scans the information security risks to generate a scanning result. In Steps S26˜S28, the information security risk analyzer 230 collects the result for monitoring or scanning the controlled 5G open architecture system 300 and determines whether to need to perform AI analysis on the scanning result. If the result is yes, the AI module analyzer 250 provides relevant analytical recommendations based on rules made by the intelligent monitoring scheduling module 260 and then the process proceeds to Step S30. If the result is no, the process proceeds to Step S30. In Step S30, the scanning result and the analytical recommendations are transmitted back to the 5G open architecture central management system 100 and the 5G virtualized infrastructure information security monitoring system 200 according to requirements.

During the scanning stage, the AI module scanner 240 provides signal transmissions containing, but not limited to, the following control instructions according to scanning or monitoring scheduling requirements.
1. Combinations of standard connection signals of control plane: When the AI module scanner 240 establishes a control plane connection with the specified controlled 5G open architecture system 300 based on 3rd generation partnership project (3GPP) standard or open radio access network (O-RAN) standard. The control signal includes combinations of a connection version, virtualization-related parameters, statistic information, relevant control plane parameters, and data fields expected to be collected. The controlled 5G open architecture system 300 generates a corresponding control signal based on results related to information exchanged with the AI module scanner 240. The controlled 5G open architecture system 300 starts up, shuts down, or establishes a connection based on the control signal, and sequentially reports real-time messages and results of scanning or monitoring the controlled 5G open architecture system 300 back to the AI module scanner 240.
2. Customized connection signals of control plane: When the AI module scanner 240 establishes a control plane connection with the specified controlled 5G open architecture system 300 based on non-3rd generation partnership project (3GPP) standard or non-open radio access network (O-RAN) standard. The control plane connection includes process discrepancies, various transmission protocols, or erroneous packet headers or contents, enabling completion of scanning on information security risks, fuzz testing, or message comparison for databases. The control signal includes combinations of a connection version, virtualization-related parameters, statistic information, relevant control plane parameters, and data fields expected to be collected. The controlled 5G open architecture system 300 generates a corresponding control signal based on results related to information exchanged with the AI module scanner 240. The controlled 5G open architecture system 300 starts up, shuts down, or establishes a connection based on the control signal, and sequentially reports real-time messages and results of scanning or monitoring the controlled 5G open architecture system 300 back to the AI module scanner 240.
3. Specified data of data plane: When the AI module scanner 240 establishes a data plane connection with the specified controlled 5G open architecture system 300 based on 3rd generation partnership project (3GPP) standard. Data plane messages transmitted by the data plane connection include combinations of data types, relevant data plane parameters, and data fields expected to be collected. The controlled 5G open architecture system 300 generates a corresponding control signal based on results related to information exchanged with the AI module scanner 240. The controlled 5G open architecture system 300 starts up, shuts down, or establishes a connection based on the control signal, and sequentially reports real-time messages and results of scanning or monitoring the controlled 5G open architecture system 300 back to the AI module scanner 240.
4. Customized data of data plane: When the AI module scanner 240 establishes a data plane connection with the specified controlled 5G open architecture system 300 based on non-3rd generation partnership project (3GPP) standard or non-open radio access network (O-RAN) standard. Data plane messages transmitted by the data plane connection include combinations of data types, relevant data plane parameters, and data fields expected to be collected. The controlled 5G open architecture system 300 generates a corresponding control signal based on results related to information exchanged with the AI module scanner 240. The controlled 5G open architecture system 300 starts up, shuts down, or establishes a connection based on the control signal, and sequentially reports real-time messages and results of scanning or monitoring the controlled 5G open architecture system 300 back to the AI module scanner 240.
5. Packets or telecommunication wireless signals of other specified frequencies and content: According to the control messages or data plane messages specified by the database access module 210, the AI module scanner 240 collects the messages of the internal components of the specified controlled 5G open architecture system 300 or the 5G open architecture central management system 100. The transmitted data includes, but are not limited to, information security data, historical statistic data, version information, virtualized information, error information, parameter setting information, performance data, security level information, billing data, etc.

In another embodiment of the invention, the information security risk analyzer 230 collects and provides the results of monitoring or scanning the controlled 5G open architecture system 300 to the AI module analyzer 250 for learning and analyzing the results of monitoring or scanning the controlled 5G open architecture system 300. Based on rules made by the intelligent monitoring scheduling module 260, the AI module analyzer 250 provides optimization and improvement recommendations or provides recommendations in monitoring, scanning or parameter setting next time. With the implementation of this embodiment, it is expected that the frequency of continuous or periodic monitoring or scanning, as well as the analysis time, will gradually decrease over time. Additionally, the monitoring or scanning results and improvement recommendations are rapidly analyzed using an AI-trained model.

In conclusion, the system for information security management over 5G open architecture infrastructures includes the 5G virtualized infrastructure information security monitoring system, which can provide virtualized information security monitoring results to assist the management system in evaluating the 5G open architecture central management system to make decision and provide recommendations. The 5G virtualized infrastructure information security monitoring system also generates corresponding messages for controlling the infrastructure based on virtualized information security monitoring technology. Additionally, the 5G virtualized infrastructure information security monitoring system receives the operational results of the virtualized information security monitoring technology and the controlled 5G open architecture system and provides real-time reports. These reports include recommendations and adjustments based on the information security messages of the information security monitoring technology. As a result, within the same operational environment, the invention can be automatically trained to generate the same or different numbers of security monitoring methods and steps. This allows the information security messages generated by the 5G virtualized infrastructure information security monitoring system and contents and processes transmitted by the 5G open architecture central management system to be automatically produced, thereby presenting corresponding information security management decisions. The related industries can utilize the system of the invention to possess the capability of continuously monitoring information security risks, just like having built-in intelligent antivirus software. The system can flexibly provide a control plane connection and analyze and scan the risk of data transmission of a data plane according to field requirements. The system can be flexibly customized according to testing requirements, reducing the need to purchase a large number of one-time information security equipment or hire one-time information security testing personnel.

The embodiments described above are only to exemplify the invention and not to limit the scope of the invention. Therefore, any equivalent modification or variation according to the shapes, structures, features, or spirit disclosed by the invention is to be also included within the scope of the invention.

What is claimed is:

1. A system for information security management over 5th generation mobile networks (5G) open architecture infrastructures, the system comprising:
a 5G open architecture central management system;
at least one controlled 5G open architecture system connected to the 5G open architecture central management system and configured to perform data transmission with the 5G open architecture central management system; and
a 5G virtualized infrastructure information security monitoring system arranged in the 5G open architecture central management system and configured to select the 5G open architecture central management system or the at least one controlled 5G open architecture system as a scanning target for monitoring, wherein the 5G virtualized infrastructure information security monitoring system, comprising multiple types of information security risk models, is configured to scan the scanning target based on usage restrictions of one of the multiple types of information security risk models, thereby generating an information security risk result, and the 5G virtualized infrastructure information security monitoring system is configured to provide an analytical recommendation based on the information security risk result.

2. The system for information security management over 5G open architecture infrastructures according to claim 1, wherein the 5G open architecture central management system comprises:
at least one control interface connected to the at least one controlled 5G open architecture system;
an underlying management control layer connected to the at least one control interface; and
an intelligent controller management platform comprising the 5G virtualized infrastructure information security monitoring system, wherein the intelligent controller management platform is connected to the at least one control interface through the underlying management control layer, thereby connecting to the at least one controlled 5G open architecture system, and the intelligent controller management platform is configured to start up the 5G virtualized infrastructure information security monitoring system, thereby starting to exchange transmission information with the at least one controlled 5G open architecture system.

3. The system for information security management over 5G open architecture infrastructures according to claim 2, wherein the 5G virtualized infrastructure information security monitoring system comprises:
a database access module configured to store the information security risk models;
an intelligent monitoring scheduling module connected to the database access module and configured to select one of the information security risk models;
an intelligent monitoring module connected to the intelligent monitoring scheduling module and configured to employ the intelligent monitoring scheduling module to select the controlled 5G open architecture system, the 5G open architecture central management system, the intelligent controller management platform, or the 5G virtualized infrastructure information security monitoring system and provide it for the database access module to monitor, and the database access module is configured to monitor and store usage restrictions of the information security risk models and the information security risk result for the scanning target in the intelligent monitoring module;
an artificial intelligence (AI) module scanner connected to the intelligent monitoring scheduling module and configured to monitor or scan an object selected by the intelligent monitoring module, wherein the AI module scanner is configured to determine whether there is an information security risk based on the information security risk model selected by the intelligent monitoring scheduling module;
an information security risk analyzer connected to the intelligent monitoring scheduling module and configured to collect results monitored or scanned by the AI module scanner, wherein the information security risk analyzer is configured to determine whether artificial intelligence (AI) analysis needs to be performed on the information security risk based on rules made by the intelligent monitoring scheduling module; and
an artificial intelligence (AI) module analyzer connected to the intelligent monitoring scheduling module, wherein when the information security risk analyzer determines that AI analysis needs to be performed on the information security risk, the AI module analyzer provides relevant analytical recommendations.

4. The system for information security management over 5G open architecture infrastructures according to claim 3, wherein the 5G virtualized infrastructure information security monitoring system further includes a virtualized underlying layer, which is connected to the database access module, the intelligent monitoring scheduling module, the intelligent monitoring module, the AI module scanner, the information security risk analyzer, and the AI module analyzer and configured to coordinate resources of the 5G virtualized infrastructure information security monitoring system.

5. The system for information security management over 5G open architecture infrastructures according to claim 3, wherein when the intelligent monitoring module selects the intelligent controller management platform, a module within the intelligent controller management platform that is at the same level as the 5G virtualized infrastructure information security monitoring system is selected.

6. The system for information security management over 5G open architecture infrastructures according to claim 3, wherein when the AI module scanner establishes a control plane connection with the specified controlled 5G open architecture system based on 3rd generation partnership project (3GPP) standard or open radio access network (O-RAN) standard, the controlled 5G open architecture system generates a corresponding control signal based on results related to information exchanged with the AI module scanner, and the controlled 5G open architecture system starts up, shuts down, or establishes a connection based on the control signal, and sequentially reports real-time messages and results of scanning or monitoring the controlled 5G open architecture system back to the AI module scanner.

7. The system for information security management over 5G open architecture infrastructures according to claim 6, wherein the control signal comprises combinations of a connection version, virtualization-related parameters, statistic information, relevant control plane parameters, and data fields expected to be collected.

8. The system for information security management over 5G open architecture infrastructures according to claim 3, wherein when the AI module scanner establishes a control plane connection with the specified controlled 5G open architecture system based on non-3rd generation partnership project (3GPP) standard or non-open radio access network (O-RAN) standard, the controlled 5G open architecture system generates a corresponding control signal based on results related to information exchanged with the AI module scanner, and the controlled 5G open architecture system starts up, shuts down, or establishes a connection based on the control signal, and sequentially reports real-time messages and results of scanning or monitoring the controlled 5G open architecture system back to the AI module scanner, wherein the control signal comprises combinations of a connection version, virtualization-related parameters, statistic information, relevant control plane parameters, and data fields expected to be collected.

9. The system for information security management over 5G open architecture infrastructures according to claim 8, wherein the control plane connection comprises process discrepancies, various transmission protocols, or erroneous packet headers or contents, enabling completion of scanning on information security risks, fuzz testing, or message comparison for databases.

10. The system for information security management over 5G open architecture infrastructures according to claim 3, wherein when the AI module scanner establishes a data plane connection with the specified controlled 5G open architecture system based on 3rd generation partnership project (3GPP) standard, the controlled 5G open architecture system generates a corresponding control signal based on results related to information exchanged with the AI module scanner, and the controlled 5G open architecture system starts up, shuts down, or establishes a connection based on the control signal, and sequentially reports real-time messages and results of scanning or monitoring the controlled 5G open architecture system back to the AI module scanner, wherein data plane messages transmitted by the data plane connection comprise combinations of data types, relevant data plane parameters, and data fields expected to be collected.

11. The system for information security management over 5G open architecture infrastructures according to claim 3, wherein when the AI module scanner establishes a data plane connection with the specified controlled 5G open architecture system based on non-3rd generation partnership project (3GPP) standard or non-open radio access network (O-RAN) standard, the controlled 5G open architecture system generates a corresponding control signal based on results related to information exchanged with the AI module scanner, and the controlled 5G open architecture system starts up, shuts down, or establishes a connection based on the control signal, and sequentially reports real-time messages and results of scanning or monitoring the controlled 5G open architecture system back to the AI module scanner, wherein data plane messages transmitted by the data plane connection comprise combinations of data types, relevant data plane parameters, and data fields expected to be collected.

12. The system for information security management over 5G open architecture infrastructures according to claim 1, wherein the controlled 5G open architecture system comprises a central unit, a distributed unit, a radio unit, and an antenna.
